(19) United States
(12) Patent Application Publication
(10) Pub. No.: US 2015/0323326 A1
(43) Pub. Date: Nov. 12, 2015

(54) METHOD AND APPARATUS FOR VEHICLE LOCATION UPDATES

(71) Applicant: FORD GLOBAL TECHNOLOGIES, LLC, Dearborn, MI (US)

(72) Inventors: Narayanan ARAVIND, Kochi (IN); VM DEVADAS, Thrissur (IN); Sreekanth V. S, Chennai (IN); Vyamajala RADHA, Hyderabad (IN)

(21) Appl. No.: 14/707,155

(22) Filed: May 8, 2015

(30) Foreign Application Priority Data
May 8, 2014 (IN) 2304/CHE/2014

(51) Int. Cl. G01C 21/26; G08G 1/127

(52) U.S. Cl. CPC G01C 21/26; G08G 1/127

(57) ABSTRACT

A system includes a processor configured to receive destination input. The processor is also configured to request contact input to which notification is to be made when a destination is reached. Further, the processor is configured to recognize when a vehicle has reached a destination specified by the destination input and automatically notify a contact associated with the contact input when the vehicle reaches the destination.

### CROSS-REFERENCE TO RELATED APPLICATIONS

This application claims foreign priority benefits under 35 U.S.C. §119(a)-(d) to IN 2304/CHE/2014 filed May 8, 2014, which is hereby incorporated by reference in its entirety.

### TECHNICAL FIELD

This invention generally relates to a method and apparatus for vehicle location updates.

### BACKGROUND

Mobile device usage has become extensive in today's world with the advent of smart phones. People are constantly connected using cell phones, email, texting and other technological communication. As a result, it is increasingly common to let interested parties know about changes in plans, location updates and other information relating to travel. Of course, sometimes the bustle of life gets in the way, and a traveling party may forget to provide an expected or requested update. Very often, a first user and a second user have both GPS enabled mobile devices cannot easily inform the other user about their current location.

U.S. Pat. No. 7,167,796 generally relates to a navigation system for a vehicle that includes a vehicle-based telematics system, a vehicle-based global positioning system and a control. The telematics system is operable to receive a user input from a driver of the vehicle and to download directional information from an external service provider to the control in response to the user input and an initial geographic position of the vehicle. The directional information comprises at least two instructions with each of the instructions being coded or associated with or linked to a respective geographic location. The control is operable to provide an output corresponding to each of the instructions in response to a current actual geographic position of the vehicle. The control is operable to provide each instruction only when the then current actual geographic position of the vehicle at least generally corresponds to the particular geographic location associated with the instruction.

U.S. patent application Ser. No. 2003/0216859 generally relates to a route guidance system for vehicles including a central computing apparatus and a transmitting apparatus by way of which the central computing apparatus is informed of the positions of respective vehicles on a road network and by way of which the vehicles are supplied with route guidance data calculated by the central computing apparatus as to the best routes for the respective vehicles to take to respective desired destinations. The transmitting apparatus includes transmitting devices for carrying by the respective vehicles and by way of which the central computing apparatus is informed as to the desired destinations. A computing apparatus serves to inform the central computing apparatus as to traffic congestion on the network. Speech synthesizers may be provided for carrying by the respective vehicles and arranged to speak instructions to the drivers of respective vehicles as to the routes to be taken to their respective desired destinations.

### SUMMARY

According to a first aspect of the invention, a system includes a processor configured to receive destination input. The processor is also configured to request contact input to which notification is to be made when a destination is reached. Further, the processor is configured to recognize when a vehicle has reached a destination specified by the destination input and automatically notify a contact associated with the contact input when the vehicle reaches the destination.

According to a second aspect of the invention, a system includes a processor configured to recognize that a vehicle has reached a destination. The processor is also configured to retrieve a contact for whom notification has been requested, prior to reaching the destination, when the destination is reached and automatically notify the contact when the destination is reached.

According to a third aspect of the invention, a system includes a vehicle-based processor configured to receive specification of a contact for an automatic notification status. The processor is also configured to receive a destination to be associated with the contact, such that the contact is notified whenever the destination is reached by a vehicle and automatically notify the contact whenever the vehicle reaches the destination.

### BRIEF DESCRIPTION OF THE DRAWINGS

FIG. 1 is an illustrative vehicle computing system;

FIG. 2 is an illustrative example of a notification setup process;

FIG. 3 is an illustrative example of a notification selection process;

FIG. 4 is an illustrative example of a reporting process; and

FIGS. 5A and 5B are illustrative examples of further reporting and contact selection processes.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

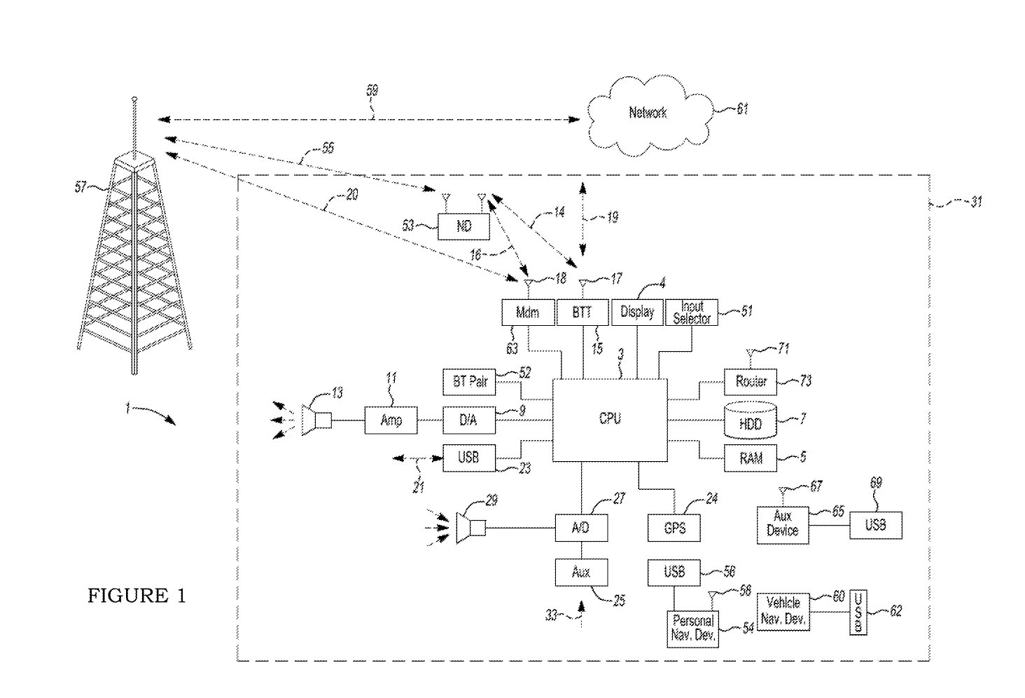

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, audible speech and speech synthesis.

In the illustrative embodiment 1 shown in FIG. 1, a processor 3 controls at least some portion of the operation of the vehicle-based computing system. Provided within the vehicle, the processor allows on-board processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a universal serial bus (USB) input 23, a global positioning system (GPS) input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a controller area network (CAN) bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as personal navigation device (PND) 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, personal digital assistant (PDA), or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the central processing unit (CPU) is instructed that the onboard BLUETOOTH transceiver will be paired with a BLUETOOTH transceiver in a nomadic device.

Data may be communicated between CPU 3 and network 61 utilizing, for example, a data-plan, data over voice, or dual-tone multi-frequency (DTMF) tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as infrared data association (IrDA)) and non-standardized consumer infrared (IR) protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of with Code Domian Multiple Access (CDMA), Time Domain Multiple Access (TDMA), Space-Domian Multiple Access (SDMA) for digital cellular communication. These are all ITU IMT-2000 (3G) compliant standards and offer data rates up to 2 mbs for stationary or walking users and 385 kbs for users in a moving vehicle, 3G standards are now being replaced by IMT-Advanced (4G) which offers 100 mbs for users in a vehicle and 1 gbs for stationary users. If the user has a data-plan associated with the nomadic device, it is possible that the data- plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (firewire), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

To address the possibility that a driver may forget to check in with someone else when a destination or waypoint is reached, the illustrative embodiments provide examples of processes usable to automatically check-in. This can help children report to parents when a destination is reached, driver's on long drives can report back to loved ones, and generally it relieves the driver of the burden of remembering to make a call, since the reporting can be made automatic through use of the illustrative embodiments.

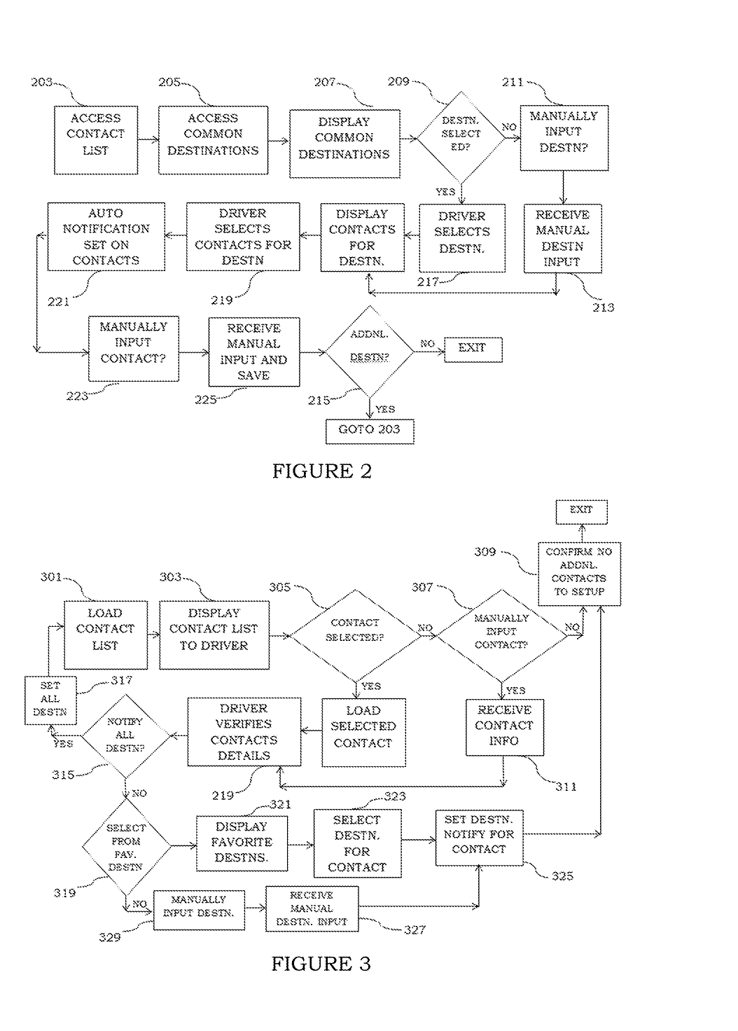

FIG. 2 shows an illustrative example of a notification setup process. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, a user will set up a list of contacts for whom some form of consistent reporting is desired. For example, with respect to certain destinations, a user may want to always notify certain contacts when those destinations are reached. A child could always notify a parent when a school destination is reached and when a home destination is reached. A spouse could always notify the other spouse when a home destination is reached. Through the process shown in FIG. 2, certain destinations can be associated with certain contacts so that notification is provided to those contacts every time the designated destination is reached, without having to request notification each time the vehicle is driven.

In this illustrative example, contact setup is initiated 201. The process will access a driver contact-list 203 (stored in the vehicle, for example), and will access a list of common destinations 205 (favorites, recent, observed common destinations, etc.). The destinations will then be presented to the driver 207, so that one or more may be selected to have some number of contacts associated therewith for automatic communication.

If the driver selects a destination 209, the process may then present a contact list 217, asking the driver to select one or more contacts that are to be automatically notified each time the selected destination is reached. If any contacts are selected 219, the process can set a status associated with those contacts 221 so as to automatically notify those contacts when the selected destination is reached. Once all contacts, if any, have been selected, the process may also wish to ask the driver if any contacts are to be manually input for notification. These may be contacts other than those on the list. If manual input is desired 223, the process will receive the contact information 225 and save the information with a status that the input information is to be used for notification when the selected destination is reached 221. If no additional contacts remain to be added, the process may check for additional destinations to be configured 215.

If the driver does not select a destination, the process may ask if the driver wishes to manually input a destination 211 with which to associate one or more repeated automatic notifications. If the driver wishes to perform the manual input 211, the process will receive the input 213 and proceed to associate contacts with the destination. This allows for input of destinations which may not appear on a favorites or recent list, but which are common destinations. For example, a driver may never input a work address into a navigation system, because the driver knows where the work is. But, at the same time, the driver may wish to notify a spouse when the driver reaches work. In such a case, the driver could put the work address in as manual input, and the spouse would be saved (via driver selection) as a contact to notify when the input address was reached.

Once any manual input is completed, the process will check to see if additional destinations need setting up 215. If not, the process exits. Otherwise, the process will continue until all desired destinations are setup.

FIG. 3 shows an illustrative example of a notification selection process. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, the process allows for selection of particular contacts, and then association of one or more destinations with each of those contacts. As opposed to FIG. 2, which associated contacts with destinations, this process associates destinations with contacts, and is merely a different way of approaching a long-term notification setup.

In this example, the process loads a contact list 301 and presents the list to a driver 303. From this list, the driver can select a contact who is to have one or more destinations associated therewith 305. If no contact is selected, an option for manual input 307 also exists. If no manual input is desired, the process confirms that no additional contacts are to be set up before the process is to exit 309.

If manual contact input is desired, the process receives the input containing at least information through which the contact can be contacted 311, otherwise, the selected contact is loaded. The contact information may then be shown so the driver can verify the party to which the information is sent, and the contact information to be used for communication. Notifications can be in the form of emails, texts, pre-recorded phone messages, or any other suitable medium.

Once the contact is displayed, the driver has an option to select “notify for all destinations” 315. This may be desirable, for example, if a young driver has the vehicle. In such a case, both parents could be notified every time the vehicle reaches any destination, adding to the parent's sense of security with respect to having the young driver alone with the vehicle. If an “all destination” status is set for the contact 317, the process does not need specific destinations identified and so will loop, looking for more contacts to be setup.

If the contact is only to have select destinations associated therewith, the process will ask a driver if a list of favorites and/or known destinations is desired 319. If so, the process will present a list of favorites/known destinations for selection 321. From this list, the driver can select any destinations to be associated with that particular contact 323. For example, a contact “Mom” may have the favorite destinations “school” and “home” associated therewith, so that a mother is notified each time a child arrives at school and arrives home from school. The notification status for each destination is associated with the selected contact 325, so that the selected contact can be notified whenever the destination is reached. Reaching a destination can be recognized, for example, by a correlation of vehicle coordinates with destination coordinates, or, when no destination is specified, by a placement of the vehicle in a park state or through other suitable methodology.

If manual input is desired 329, as opposed to selection of a known destination, or in addition to such selection, and the process will receive input of a destination 327. Once all destination data has been input, the process will check to ensure that no other destinations remain to be selected or input 331. If not, the process will check to see if additional contacts need notification data set 309.

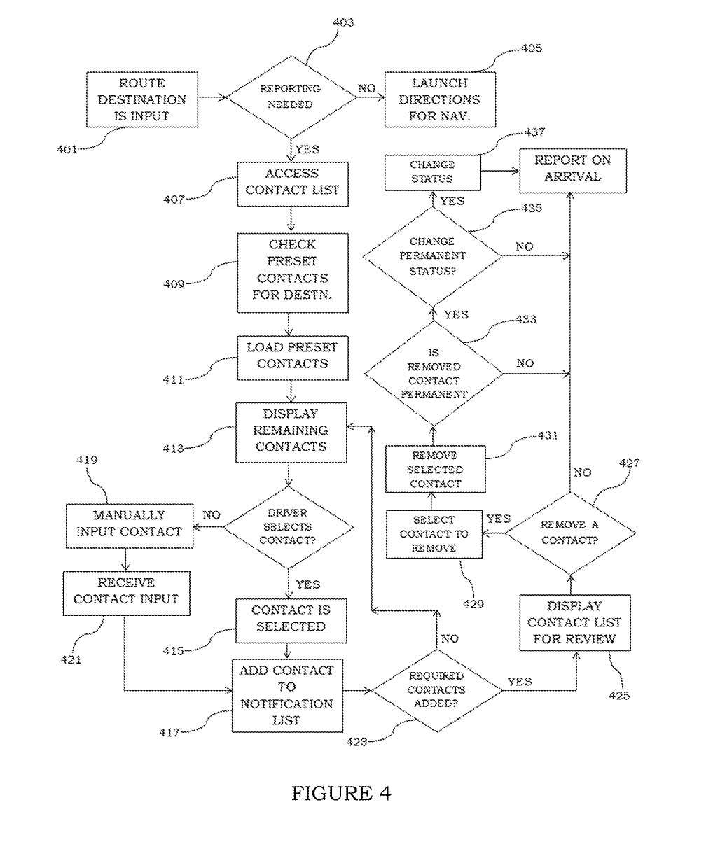

FIG. 4 shows an illustrative example of a reporting process. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, a route destination is input and the process provides an option to select/input one or more contacts to be automatically notified when the destination is reached. The process begins when a destination is input 401. If reporting is not desired (or if reporting only to preset contacts is desired) 403, the process may proceed with launching directions for navigation 405.

If one or more contacts are to be notified, the process may access a contact list 407. For example, a child may be driving to visit an older sibling at college. The child may already have “mom” and “dad” set as “notify always” contacts, so these contacts will be automatically notified when the child reaches the destination. But the child may also wish to select “sister” (the college student) as an automatic notification contact, so that the sister is also notified when the child arrives. Then, when the child arrives at the destination, the mother, the father and the sister will all be automatically notified of the arrival.

Once the contact list has been accessed, the process checks to see if any contacts have been previously associated with this address (e.g., “notify always” contacts, or “notify always for this address” contacts) 409. If any such contacts exist, those contacts are loaded to a list used for reporting when the destination is reached 411. Remaining contacts may then be presented 413. The already loaded contacts may or may not be included in the remaining contact presentation. If included, they may have some designation associated therewith, so the driver knows they have already been added to the notify list.

From the list, the driver may then select one or more additional contacts. If any are selected 415, the process will add these contacts to the notification list 417. In this example, adding the contacts to the list in this manner sets the contacts as one-off notification prospects, that is, they won't automatically be notified in the future when the destination is achieved, beyond this journey.

Further, the driver may be given the option to manually input contact information. If the driver elects to input this information 419, the process will receive the input from the driver 421 and add the input to the list. Once the driver has added all appropriate parties 423, the process will present a list for the driver's review 425.

The presented list may show all parties selected to be contacted when the vehicle reaches the destination. The driver can review the list, and can, if desired, elect to remove a party from the list 427.

If the driver elects to remove a party from the list, the party to be removed is selected by the driver 429. This party is removed from the list 431. In this example, the process also checks to see if the removed party has some permanent association with the destination 433. If so, the process asks if the driver wishes to change the status of the removed party (such that the party is not automatically always notified when this destination is reached) 435. If a status change is desired, the process changes the status 437. At this point, the driver begins the journey and, once the driver arrives, notification will be provided to the selected parties.

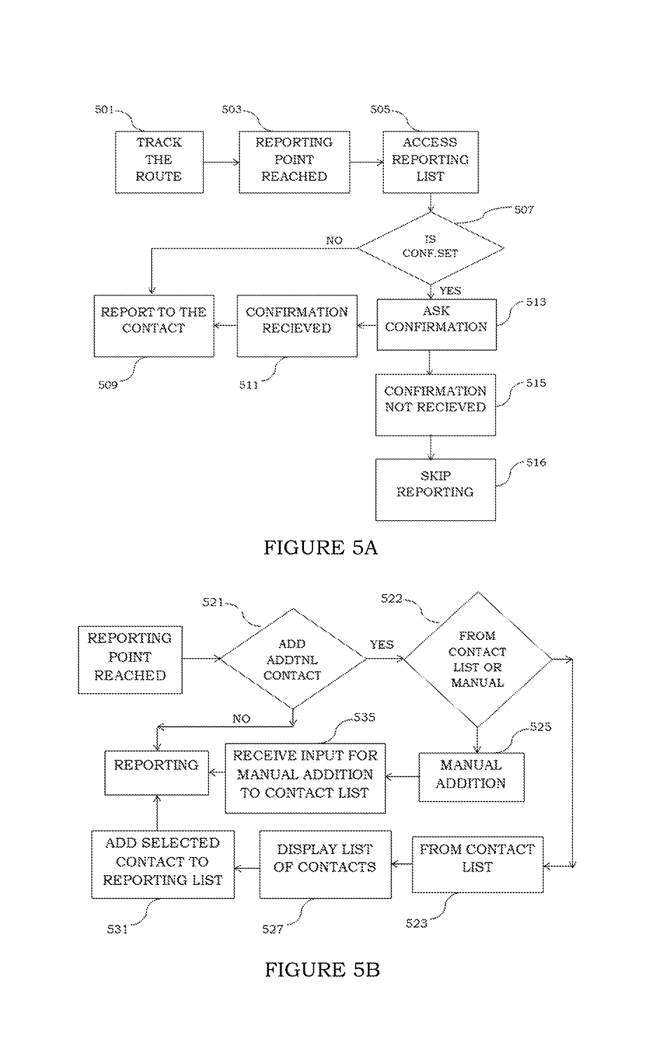

FIGS. 5A and 5B show illustrative examples of further reporting and contact selection processes. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

FIG. 5A shows an illustrative example for reporting arrival at a destination. The process will track the route as the driver progresses 501. If a reporting point (e.g., destination or any other specified reporting point) is reached 503, the process will access the pre-established reporting list 505. In this example, the process may have a confirmation option that can be set.

If the confirmation option is set 507, the process will ask the driver for confirmation to send the notification 513. If confirmation is received 511, or if no confirmation is required 507, the process will report, via the appropriate communication format, that the driver has reached the destination or reporting point 509. If permission is denied 515, the process will skip the reporting 516 and, following skipping reporting or reporting, the process will continue to track the vehicle until the destination is reached.

FIG. 5B shows an illustrative example of a process for reporting to additional contacts. In an example where one or more reporting points are used, the process may provide for addition of parties to the reporting list whenever reporting is performed. In this example, when a reporting point is reached, the process will ask if additional parties should be added 521. In this manner, if a driver forgot to add a party at the journey's beginning, that party can be added now.

If additional parties should be added, the process 522 will ask if the party is from a contact list or from manual input. If the party is from the contact list 523, the process will present a list of contacts 527 from which relevant parties can be selected. If at least one party is selected, that party will be added to the reporting list 531.

If manual input is selected 525, the process will receive any input relating to manual additions to the contact list 535. These parties can also be added to the contact list. This additional party option is an optional step that can be added if desired, to provide a convenient way to update a list with a party forgotten at the beginning of a journey.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a processor configured to:
receive destination input;
request contact input to which notification is to be made when a destination is reached;
recognize when a vehicle has reached a destination specified by the destination input; and
automatically notify a contact associated with the contact input when the vehicle reaches the destination.

2. The system according to claim 1, wherein the contact input includes selection from a list of known contacts.

3. The system according to claim 1, wherein the contact input includes manual input of new contact information.

4. The system according to claim 1, wherein the automatically notify includes automatic notification to the contact via email.

5. The system according to claim 1, wherein the automatically notify includes automatic notification to the contact via text message.

6. The system according to claim 1, wherein the automatically notify includes automatic notification to the contact via pre-recorded voice message.

7. A system comprising:
a processor configured to:
recognize that a vehicle has reached a destination;
retrieve a contact for whom notification has been requested, prior to reaching the destination, when the destination is reached; and
automatically notify the contact when the destination is reached.

8. The system of claim 7, wherein the processor is configured to recognize that a vehicle has reached a destination through inception of a vehicle park state.

9. The system of claim 7, wherein the processor is configured to recognize that a vehicle has reached a destination through correlation of vehicle coordinates and input destination coordinates.

10. The system of claim 7, wherein the contact has a predefined association with the destination, specifying that the contact be notified each time the destination is reached.

11. The system of claim 7, wherein the contact was specified at a journey's inception as a contact to be notified when a destination was reached.

12. The system of claim 7, wherein the automatically notify includes automatic notification to the contact via email.

13. The system of claim 7, wherein the automatically notify includes automatic notification to the contact via text message.

14. The system of claim 7, wherein the automatically notify includes automatic notification to the contact via pre-recorded voice message.

15. A system comprising:
a vehicle-based processor configured to:
receive specification of a contact for an automatic notification status;
receive a destination to be associate with the contact, such that the contact is notified whenever the destination is reached by a vehicle; and
automatically notify the contact whenever the vehicle reaches the destination.

16. The system of claim 15, wherein the contact is specified by selection from a list of known contacts.

17. The system of claim 15, wherein the contact is specified by manual input of new contact information.

18. The system of claim 15, wherein the destination is selected from a list of known destinations.

19. The system of claim 15, wherein the destination is manually input as a new destination.

20. The system of claim 15, wherein the destination is specified as all destinations, such that the contact is notified whenever any destination is reached by the vehicle.
